(19) United States
(12) Patent Application Publication
(10) Pub. No.: US 2021/0405311 A1
(43) Pub. Date: Dec. 30, 2021

(54) OPTICAL FIBER CONNECTOR ATTACH TO DIE IN WAFER OR PANEL LEVEL TO ENABLE KNOWN GOOD DIE

(71) Applicant: Intel Corporation, Santa Clara, CA (US)

(72) Inventors: Xiaoqian LI, Chandler, AZ (US); Nitin DESHPANDE, Chandler, AZ (US); Omkar KARHADE, Chandler, AZ (US)

(21) Appl. No.: 16/911,764

(22) Filed: Jun. 25, 2020

(51) Int. Cl. G02B 6/42; G02B 6/43

(52) U.S. Cl. CPC G02B 6/4243; G02B 6/4214; G02B 6/428; G02B 6/43; G02B 6/4255

(57) ABSTRACT

Embodiments disclosed herein include electronic packages with photonics modules. In an embodiment, a photonics module comprises a carrier substrate and a photonics die over the carrier substrate. In an embodiment, the photonics die has a first surface facing away from the carrier substrate and a second surface facing the carrier substrate, and a plurality of V-grooves are disposed on the first surface proximate to an edge of the photonics die. In an embodiment, the photonics module further comprises a fiber connector attached to the photonics die, where the fiber connector couples a plurality of optical fibers to the photonics die. In an embodiment, individual ones of the plurality of optical fibers are positioned in the V-grooves.

### TECHNICAL FIELD

Embodiments of the present disclosure relate to semiconductor devices, and more particularly to electronic packages with optical fiber connectors.

### BACKGROUND

V-groove features have been used in photonics dies in order to enable passive fiber alignment. However, there has not been a well-defined architecture or process flow to integrate a fiber connector with a flip-chip package. In the current architecture, the photonics die is attached to a substrate. The photonics die overhangs an edge of the substrate to allow for V-grooves to be accessed. After underfill of first level interconnects, an integrated heat spreader (IHS) is attached. Thereafter, a fiber connector with a pig tail is attached to the V-groove. Accordingly, the fiber attach process occurs after many assembly operations.

Additionally, the large number of optical fibers leads to low yields. For example, there may be 24 fibers per photonics die, and as many as six photonics die per package. Assuming a 99% yield for each fiber alignment in the V-grooves, overall yield projections of having all fibers aligned properly is only 23%.

### BRIEF DESCRIPTION OF THE DRAWINGS

FIG. 1A is a plan view illustration of a photonics module, in accordance with an embodiment.

FIG. 1B is a side view of the photonics module in FIG. 1A, in accordance with an embodiment.

FIG. 1C is a cross-sectional illustration of the photonics module in FIG. 1A along line C-C′, in accordance with an embodiment.

FIG. 1D is a cross-sectional illustration of the photonics module in FIG. 1A along line D-D′, in accordance with an embodiment.

FIG. 2A is a plan view illustration of a photonics module with a reflective surface and an array of micro lenses, in accordance with an embodiment.

FIG. 2B is a cross-sectional illustration of the photonics module in FIG. 2A along line B-B′, in accordance with an embodiment.

FIG. 3A is a cross-sectional illustration of a photonics module with an interposer at a first stage of assembly, in accordance with an embodiment.

FIG. 3B is a cross-sectional illustration of a photonics module with an interposer at a second stage of assembly, in accordance with an embodiment.

FIG. 3C is a side view illustration of the photonics module in FIG. 3B, in accordance with an embodiment.

FIG. 4A is a cross-sectional illustration of a photonics module with an interposer and a reflective surface, in accordance with an embodiment.

FIG. 4B is a cross-sectional illustration of the photonics module in FIG. 4A after the formation of an array of micro lenses, in accordance with an embodiment.

FIG. 5A is a cross-sectional illustration of a photonics module with a buffer lid at a first stage of assembly, in accordance with an embodiment.

FIG. 5B is a cross-sectional illustration of the photonics module with a buffer lid at a second stage of assembly, in accordance with an embodiment.

FIG. 6A is a cross-sectional illustration of an electronic package with a photonics module, in accordance with an embodiment.

FIG. 6B is a cross-sectional illustration of an electronic package with a photonics module, in accordance with an additional embodiment.

FIG. 7 is a cross-sectional illustration of an electronic package with a photonics module that is optically coupled to an array of micro lenses through a package substrate, in accordance with an embodiment.

FIG. 8A is a cross-sectional illustration of an electronic package with a photonics module that comprises an interposer, in accordance with an embodiment.

FIG. 8B is a cross-sectional illustration of an electronic package with a photonics module that comprises an interposer and an optical path through a substrate, in accordance with an embodiment.

FIG. 9 is a cross-sectional illustration of an electronic package with a photonics module that comprises a buffer lid, in accordance with an embodiment.

FIG. 10 is a schematic of a computing device built in accordance with an embodiment.

### EMBODIMENTS OF THE PRESENT DISCLOSURE

Described herein are electronic packages with optical fiber connectors, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

As noted above, the assembly of photonics modules in electronic packages suffer from low yields. This is due in part to a large number of optical fibers needing to be properly aligned in V-grooves. Even at a high yield for individual fibers, the overall yield of an electronic package is low. When the optical fibers are attached to the photonics dies at a late stage of manufacture, the low yield becomes very costly.

Accordingly, embodiments disclosed herein include photonics modules that are assembled prior to being integrated into the electronic package. As such, only known good dies are assembled into the package, and the assembly yield is greatly improved. The higher yield reduces costs of the electronic package. In an embodiment, the photonics modules are assembled with a panel level or wafer level process. For example, a plurality of photonics dies are mounted to a carrier substrate (e.g., a panel sized substrate or wafer sized substrate). Fiber connectors housing the fibers for the photonics module are then coupled to each photonics die. Each of the assembled photonics modules may then be tested (e.g., optical testing and/or electrical testing) to determine which modules are fully functional. The fully functional photonics modules may then be integrated into electronic packages.

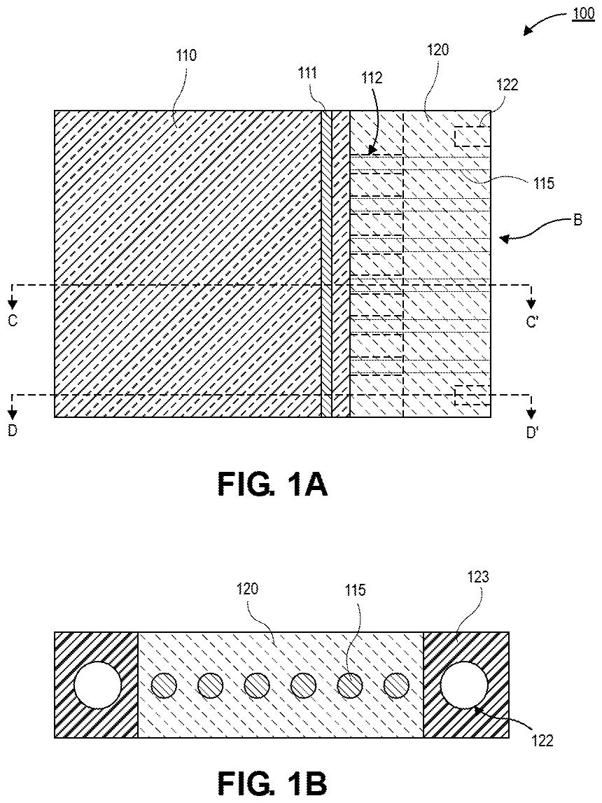

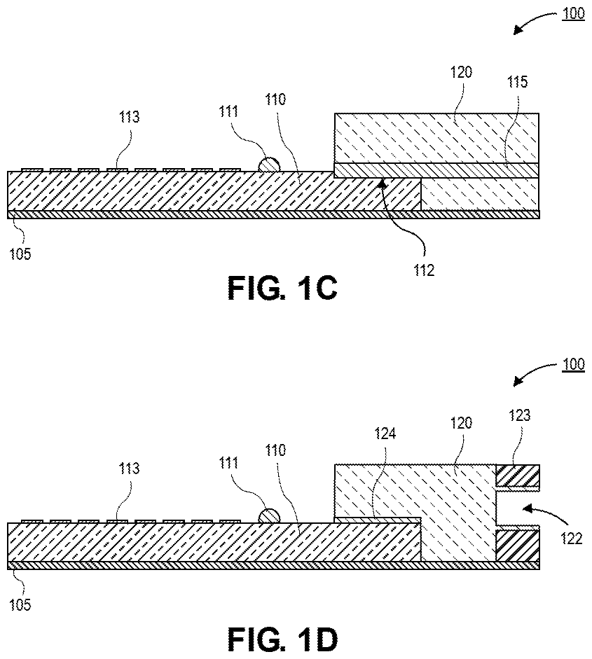

Referring now to FIG. 1A, a plan view illustration of a photonics module 100 is shown, in accordance with an embodiment. In an embodiment, the photonics module 100 may comprise a photonics die 110. The photonics die 110 includes optoelectronic circuitry for converting optical signals to electrical signals and/or for converting electrical signals to optical signals.

The photonics die 110 may comprise a plurality of V-grooves 112. The V-grooves are indicated with a dashed line to indicate that they are below the fiber connector 120. In an embodiment, a plurality of optical fibers 115 are set into the V-grooves 112. The optical fibers 115 extend to an edge of the fiber connector 120. In an embodiment, the fiber connector 120 may further comprise alignment holes 122 for receiving alignment pins to provide aligned connections to the optical fibers 115.

FIG. 1B is a side view of the photonics module 100 along edge B. As shown, the alignment holes 122 may be surrounded by a magnetic material 123 in order to enable easy assembly of cables to the photonics module 100. In the illustrated embodiment, six optical fibers 115 are shown in the fiber connector 120. However, it is to be appreciated that any number of optical fibers 115 may be included in the photonics module 100. For example, 24 optical fibers 115 may be included in the photonics module 100 in some embodiments.

Referring now to FIG. 1C, a cross-sectional illustration of the photonics module 100 in FIG. 1A along line C-C′ is shown, in accordance with an embodiment. The photonics module 100 comprises a photonics die 110 and a fiber connector 120 over a carrier substrate 105. In an embodiment, the carrier substrate 105 may be a wafer level or panel level substrate. After assembly, the carrier substrate 105 is singulated in order to provide individual photonics modules 100. The photonics die 110 and the fiber connector 120 may be adhered to the carrier substrate 105 with an adhesive (e.g., die attach film (DAF), an epoxy, or the like).

In an embodiment, the photonics die 110 comprises a plurality of pads 113 on a surface of the photonics die 110 opposite from the carrier substrate 105. In an embodiment, an epoxy barrier 111 separates the pads 113 from the connector edge of the photonics die 110. The epoxy barrier 111 prevents epoxy used to secure the optical fibers 115 in the V-grooves 112 from spreading to the pads 113.

In an embodiment, the fiber connector 120 is attached over the connector edge of the photonics die 110. For example, the fiber connector 120 is over a top surface and a sidewall surface of the photonics die 110. In an embodiment, the fiber connector 120 secures optical fibers 115 against the V-groove 112 of the photonics die 110.

Referring now to FIG. 1D, a cross-sectional illustration of the photonics module 100 in FIG. 1A along line D-D′ is shown, in accordance with an embodiment. As shown, the fiber connector 120 includes an alignment hole 122 for pins of a fiber cable (not shown). The pins may be secured into the alignment hole 122 by a magnet 123 embedded in the fiber connector 120. In the illustrated embodiment, the epoxy 124 used to secure the optical fibers 115 into the V-grooves 112 is shown between fiber connector 120 and a top surface of the photonics die 110.

Assembly and testing of the photonics module 100 may be implemented before assembly into an electronic package. This allows for only known good devices to be used, and yield is improved. In an embodiment, assembly of the photonics module 100 may include bumping the photonics die 110 and singulating the photonics die 110. The singulated photonics die 110 is attached to the carrier substrate 105. After attachment to the carrier substrate 105, the epoxy barrier 111 may be dispensed, followed by dispensing the epoxy 124 into the V-grooves 112.

The assembly may then continue with pressing the optical fibers 115 into the V-grooves 112, with the fiber connector 120 being adhered to the carrier substrate 105. In an embodiment, the fiber connector 120 is designed with an L-shape that pushes against the sidewall of the photonics die 110 to prevent the optical fibers 115 from pushing beyond the ends of the V-grooves 112. As noted above, the fiber connector 120 integrates the ferrule alignment hole 122 for receiving a mating pin of a subsequently attached cable.

In an embodiment, the carrier substrate 105 may then be singulated. A socket that can be plugged into the side (using the alignment holes 122) and contact the pads 113 from above is used to test the singulated photonics module. This allows for both electrical and optical testing to be done before the photonics module is integrated into an electronic package.

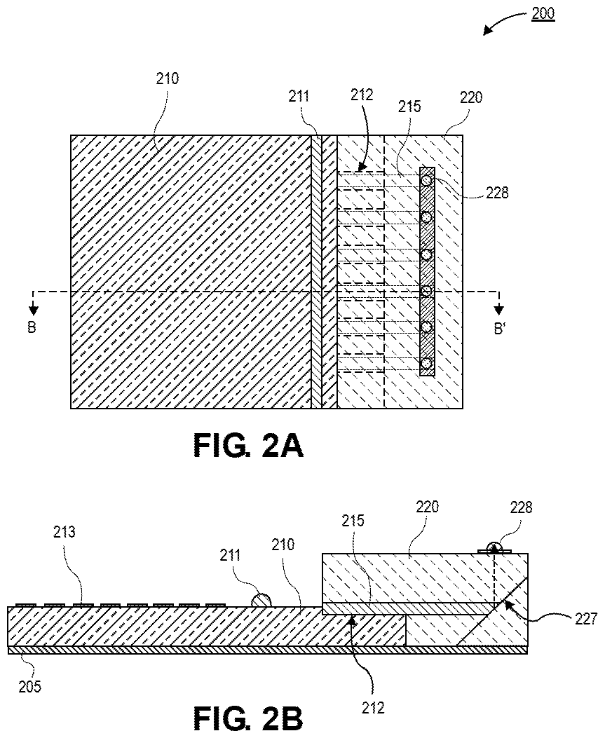

Referring now to FIG. 2A, a plan view illustration of a photonics module 200 is shown, in accordance with an embodiment. In an embodiment, the photonics module 200 comprises a photonics die 210 and a fiber connector 220 over a carrier substrate 205. In an embodiment, optical fibers 215 within the fiber connector 220 are set into V-grooves 212 of the photonics die 210. The optical fibers 215 are optically coupled to an array of micro lenses 228 on a top surface of the fiber connector 220.

Referring now to FIG. 2B, a cross-sectional illustration of the photonics module 200 in FIG. 2A along line B-B′ is shown, in accordance with an embodiment. The electrical pads 213 may be separated from the fiber connector 220 by an epoxy barrier 211. In an embodiment, the optical fibers 215 are set in the V-groove 212 of the photonics die 210.

As shown, the optical fibers 215 may terminate at a reflective surface 227. In an embodiment, the reflective surface 227 optically couples the optical fiber 215 to a micro lens 228, as indicated by the dashed arrow. In an embodiment, the reflective surface 227 is a mirror surface. In other embodiments, the reflective surface 227 may be the result of a tapered fiber end with a different refractive indexes encapsulation so an interface between two materials with different indexes of refraction can be created to deflect light beam.

Providing micro lenses 228 on the top surface of the fiber connector 220 enables easier testing architectures. This is because both the electrical pads 213 and the micro lenses 228 are facing the same direction. Accordingly, the design of a testing probe for both optical and electrical testing is simplified.

Assembly and testing of the photonics module 200 may be implemented before assembly into an electronic package. This allows for only known good devices to be used, and yield is improved. In an embodiment, assembly of the photonics module 200 may include bumping the photonics die 210 and singulating the photonics die 210. The singulated photonics die 210 is attached to the carrier substrate 205. After attachment to the carrier substrate 205, the epoxy barrier 211 may be dispensed, followed by dispensing the epoxy into the V-grooves 212.

The assembly may then continue with pressing the optical fibers 215 into the V-grooves 212, with the fiber connector 220 being adhered to the carrier substrate 205. In an embodiment, the fiber connector 220 is designed with an L-shape that pushes against the sidewall of the photonics die 210 to prevent the optical fibers 215 from pushing beyond the ends of the V-grooves 212. In an embodiment, micro lenses 228 that are optically coupled to the optical fibers 215 are disposed over the top surface of the fiber connector 220.

In an embodiment, the carrier substrate 205 may then be singulated. Optical coupling efficiency can then be tested from the top of the wafer in conjunction with electrical testing of the pads 213. This allows for both electrical and optical testing to be done before the photonics module is integrated into an electronic package.

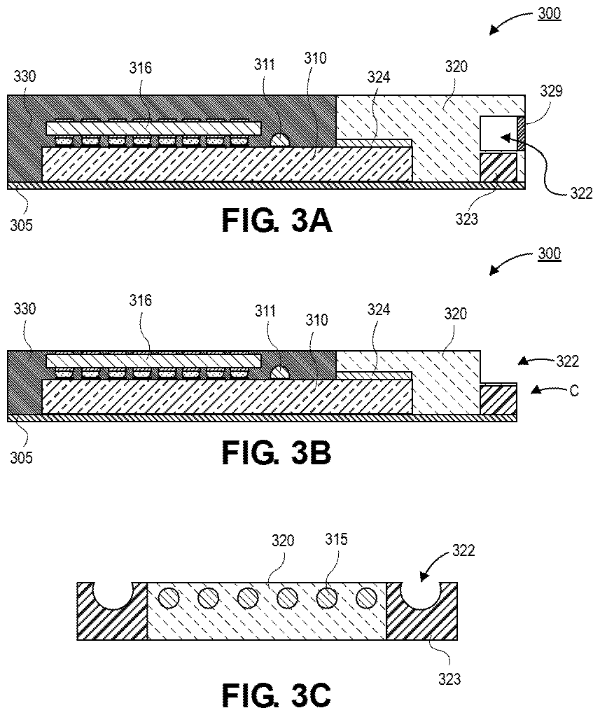

Referring now to FIG. 3A, a cross-sectional illustration of a photonics module 300 at a first stage of assembly is shown, in accordance with an embodiment. In an embodiment, the photonics module 300 comprises a photonics die 310 and a fiber connector 320 that are attached to a carrier substrate 305. In an embodiment, an interposer 316 is attached to a top surface of the photonics die 310. In some embodiments, the interposer 316 is a passive interposer. In other embodiments, the interposer 316 is an active interposer. The interposer 316 and the photonics die 310 may be embedded in a mold layer 330. In an embodiment, an epoxy barrier 311 separates the interposer 316 from the fiber connector 320 in order to prevent the spread of epoxy 324 away from the fiber connector 320.

In an embodiment, the fiber connector 320 comprises an alignment hole 322. The alignment hole 322 may be sealed by a plug 329. The plug 329 prevents the mold layer 330 from filling the alignment hole 322. A magnetic material 323 may be embedded in the fiber connector 320.

Referring now to FIG. 3B, a cross-sectional illustration of the photonics module 300 after the mold layer 330 is recessed is shown, in accordance with an embodiment. In an embodiment, the mold layer 330 is recessed in order to expose pads of the interposer 316. The recessing process may also include recessing a portion of the fiber connector 320. As shown in the side view of surface C in FIG. 3C, the recessing of the fiber connector 320 may include removing a top portion of the alignment hole 322.

Assembly and testing of the photonics module 300 may be implemented before assembly into an electronic package. This allows for only known good devices to be used, and yield is improved. In an embodiment, assembly of the photonics module 300 may include bumping the photonics die 310 and singulating the photonics die 310. The singulated photonics die 310 is attached to the carrier substrate 305. The interposer 316 may then be attached to the photonics die 310. After attachment to the interposer 316, the epoxy barrier 311 may be dispensed, followed by dispensing the epoxy 324 into the V-grooves.

The assembly may then continue with pressing the optical fibers 315 into the V-grooves, with the fiber connector 320 being adhered to the carrier substrate 305. In an embodiment, the fiber connector 320 is designed with an L-shape that pushes against the sidewall of the photonics die 310 to prevent the optical fibers 315 from pushing beyond the ends of the V-grooves. As noted above, the fiber connector 320 integrates the ferrule alignment hole 322 for receiving a mating pin of a subsequently attached cable.

In an embodiment, the mold layer 330 is dispensed over the photonics module 300. The mold layer 330 may then be recessed, as shown in FIG. 3B. In an embodiment, the carrier substrate 305 may then be singulated. The singulation process may also remove the plug 329 to provide access to the alignment hole 322. A socket that can be plugged into the side (using the alignment holes 322) and contact the interposer 316 from above is used to test the singulated photonics module 300. This allows for both electrical and optical testing to be done before the photonics module 300 is integrated into an electronic package.

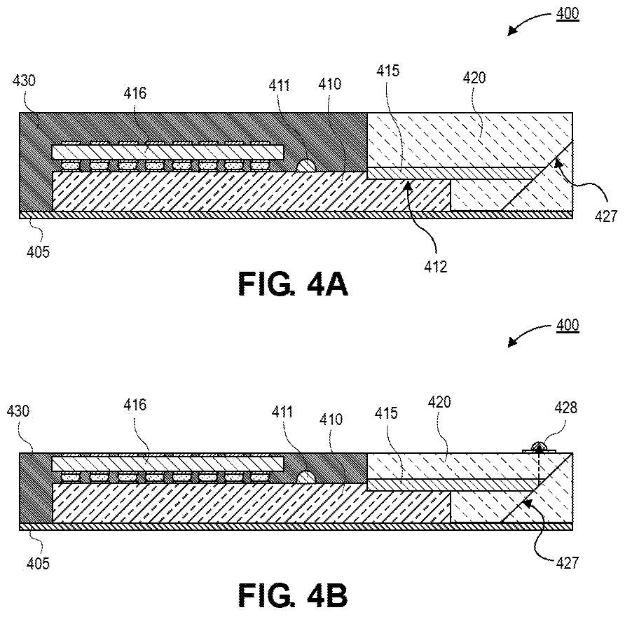

Referring now to FIG. 4A, a cross-sectional illustration of a photonics module 400 at a first stage of assembly is shown, in accordance with an embodiment. In an embodiment, the photonics module 400 comprises a photonics die 410 and a fiber connector 420 over a carrier substrate 405. In an embodiment, optical fibers 415 within the fiber connector 420 are set into V-grooves 412 of the photonics die 410. In an embodiment, an interposer 416 is disposed over the photonics die 410. The interposer 416 may be separated from the V-grooves 412 by an epoxy barrier 411. In an embodiment, a mold layer 430 is disposed over the interposer 416. As shown, the optical fibers 415 may terminate at a reflective surface 427.

Referring now to FIG. 4B, a cross-sectional illustration of the photonics module 400 at a second stage of assembly is shown, in accordance with an embodiment. In an embodiment, the mold layer 430 and part of the fiber connector 420 are recessed in order to expose pads of the interposer 416. Additionally, a micro lens 428 is disposed over a top surface of the fiber connector 420. In an embodiment, the reflective surface 427 optically couples the optical fiber 415 to the micro lens 428, as indicated by the dashed arrow. In an embodiment, the reflective surface 427 is a mirror surface. In other embodiments, the reflective surface 427 may be the result of an interface between two materials with different indexes of refraction.

Providing micro lenses 428 on the top surface of the fiber connector 420 enables easier testing architectures. This is because both the pads of the interposer 416 and the micro lenses 428 are facing the same direction. Accordingly, the design of a testing probe for both optical and electrical testing is simplified.

Assembly and testing of the photonics module 400 may be implemented before assembly into an electronic package. This allows for only known good devices to be used, and yield is improved. In an embodiment, assembly of the photonics module 400 may include bumping the photonics die 410 and singulating the photonics die 410. The singulated photonics die 410 is attached to the carrier substrate 405. The interposer 416 may then be attached to the photonics die 410. After attachment to the interposer 416, the epoxy barrier 411 may be dispensed, followed by dispensing the epoxy into the V-grooves 412.

The assembly may then continue with pressing the optical fibers 415 into the V-grooves 412, with the fiber connector 420 being adhered to the carrier substrate 405. In an embodiment, the fiber connector 420 is designed with an L-shape that pushes against the sidewall of the photonics die 410 to prevent the optical fibers 415 from pushing beyond the ends of the V-grooves 412.

In an embodiment, the mold layer 430 is dispensed over the photonics module 400. The mold layer 430 may then be recessed to expose pads of the interposer 416, as shown in FIG. 4B. After recessing the mold layer 430, the micro lenses 428 may be disposed over the top surface of the fiber connector 420. In an embodiment, the carrier substrate 405 may then be singulated. Optical coupling efficiency can then be tested from the top of the wafer in conjunction with electrical testing of the pads of the interposer 416. This allows for both electrical and optical testing to be done before the photonics module is integrated into an electronic package.

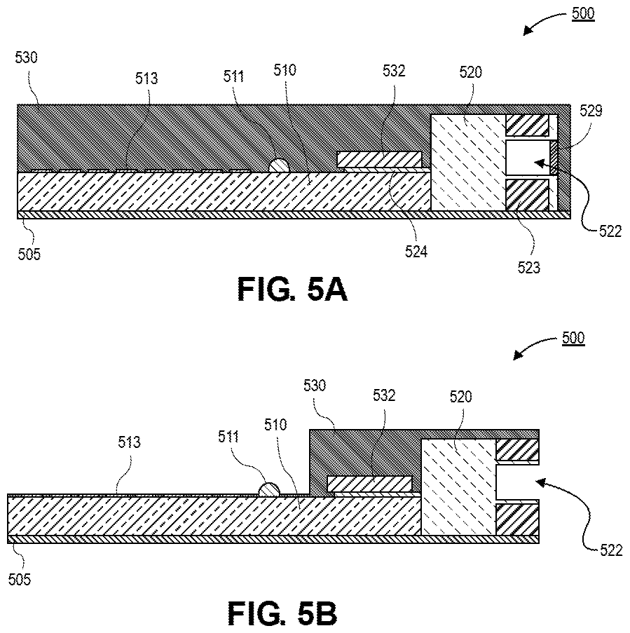

Referring now to FIG. 5A, a cross-sectional illustration of a photonics module 500 at a first stage of assembly is shown, in accordance with an embodiment. In an embodiment, the photonics module 500 comprises a photonics die 510 that is attached to a carrier 505. A fiber connector 520 may attach optical fibers to the photonics die 510. In an embodiment, a buffer lid 532 secures the optical fibers in V-grooves into the photonics die 510. The optical fibers may also be secured by an epoxy 524. In an embodiment, an epoxy barrier 511 prevents the epoxy 524 from spreading over pads 513 of the photonics die 510.

In an embodiment, the fiber connector 520 comprises an alignment hole 522 that is surrounded by a magnetic material 523. In an embodiment, the alignment hole 522 is sealed by a plug 529. The plug 529 prevents mold material of a mold layer 530 from filling the alignment hole 522.

Referring now to FIG. 5B, a cross-sectional illustration of the photonics module 500 at a second stage of assembly is shown, in accordance with an embodiment. As shown, a portion of the mold layer 530 is removed over the pads 513. For example, the mold layer 530 may be removed with a fly cutting process to expose the pads 513. The plug 529 may be removed during singulation of the photonics module 500.

Assembly and testing of the photonics module 500 may be implemented before assembly into an electronic package. This allows for only known good devices to be used, and yield is improved. In an embodiment, assembly of the photonics module 500 may include bumping the photonics die 510 and singulating the photonics die 510. The singulated photonics die 510 is attached to the carrier substrate 505. An epoxy barrier 511 may be dispensed, followed by dispensing the epoxy 524 into the V-grooves.

The assembly may then continue with pressing the optical fibers into the V-grooves, with the fiber connector 520 being adhered to the carrier substrate 505. In an embodiment, a buffer lid 532 presses the optical fibers into the V-grooves. As noted above, the fiber connector 520 integrates the ferrule alignment hole 522 for receiving a mating pin of a subsequently attached cable. The alignment hole 522 may be covered by a plug 529. After attachment of the fiber connector 520, a mold layer 530 may be disposed over the photonics module 500.

In an embodiment, the mold layer 530 may be removed from over the pads 513. For example, the mold layer 530 may be removed with a fly cut process. After removal of a portion of the mold layer 530, the photonics module 500 may be singulated. The singulation process may also include removing the plug 529 in order to expose the alignment hole 522.

A socket that can be plugged into the side (using the alignment holes 522) and contact the pads 513 from above is used to test the singulated photonics module 500. This allows for both electrical and optical testing to be done before the photonics module 500 is integrated into an electronic package.

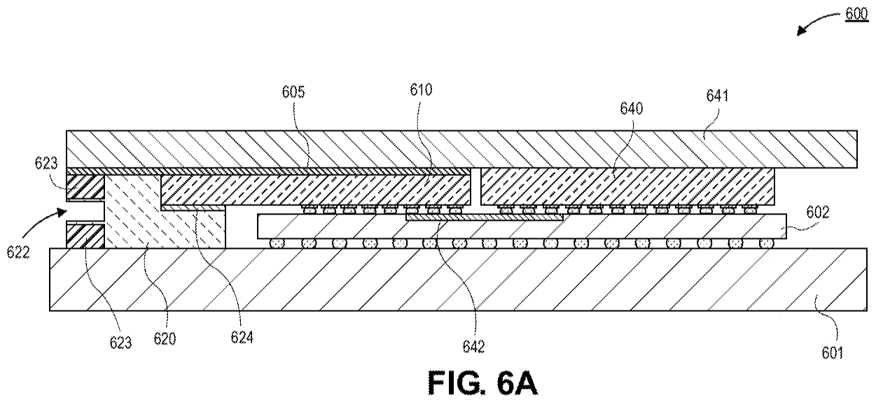

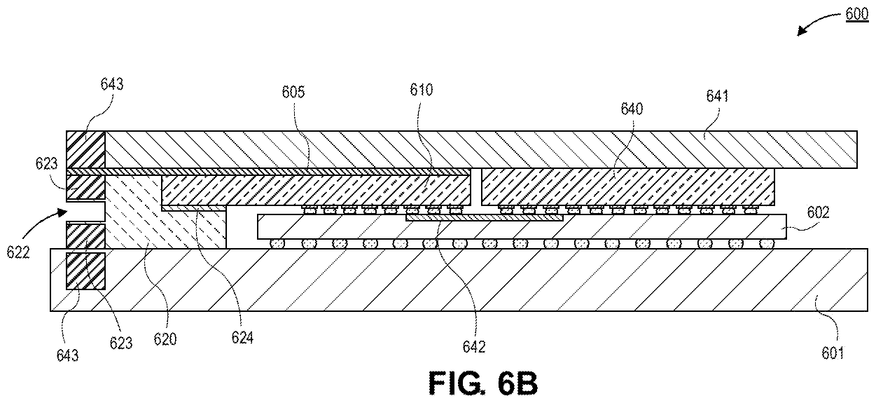

Referring now to FIG. 6A, a cross-sectional illustration of an electronic package 600 is shown, in accordance with an embodiment. In an embodiment, the electronic package 600 comprises a first substrate 601 and a second substrate 602 over the first substrate. The first substrate 601 may be attached to the second substrate 602 with interconnects, such as solder balls. In an embodiment, the first substrate 601 may be an interposer and the second substrate 602 may be a patch substrate. In an additional embodiment, the first substrate 601 is a board, and the second substrate 602 is an interposer. In an embodiment, a first die 610 and a second die 640 are attached to the second substrate 602. The first die 610 and the second die 640 may be communicatively coupled to each other by a bridge 642 in the second substrate 602. In an embodiment, the first die 610 is a photonics die and the second die 640 is a field programmable gate array (FPGA) die.

In an embodiment, the photonics die 610 is part of a photonics module that extends over an edge of the second substrate 602. In an embodiment, the photonics module in FIG. 6A may be substantially similar to the photonics module 100 illustrated in FIGS. 1A-1D. For example, the photonics module may include a fiber connector 620 for connecting optical fibers (not shown) to the photonics die 610. An epoxy 624 may secure the optical fibers to V-grooves in the photonics die 610. In an embodiment, an alignment hole 622 that is surrounded by a magnetic material 623 is provided at an edge of the fiber connector 620. In an embodiment, the fiber connector 620 and the photonics die 610 are attached to a carrier substrate 605. That is, the carrier substrate 605 may separate the photonics die 610 and the fiber connector 620 from a thermal solution such as an integrated heat spreader (IHS) 641.

Referring now to FIG. 6B, a cross-sectional illustration of an electronic package 600 is shown, in accordance with an additional embodiment. In an embodiment, the electronic package 600 in FIG. 6B is substantially similar to the electronic package 600 in FIG. 6A, with the exception that additional magnetic layers 643 are provided. In an embodiment, the additional magnetic layer 643 may be provided in one or both of the IHS 641 and the first substrate 601.

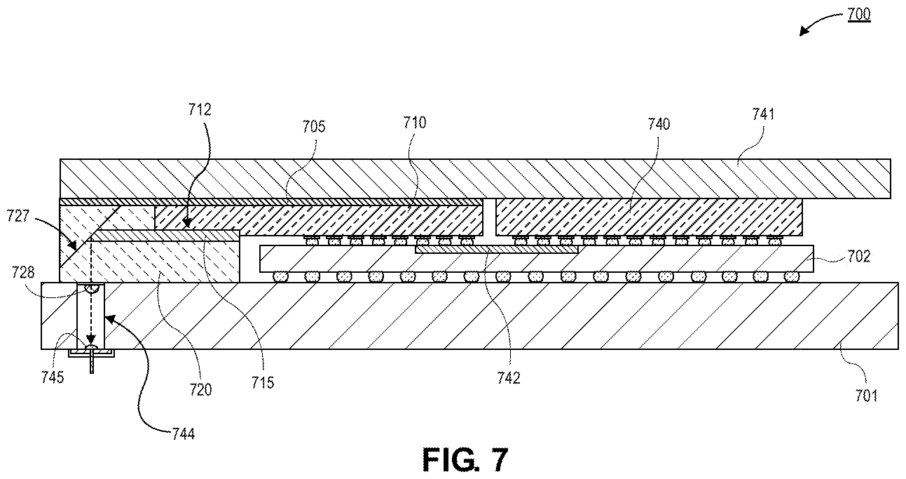

Referring now to FIG. 7, a cross-sectional illustration of an electronic package 700 is shown, in accordance with an embodiment. The electronic package 700 may comprise a first substrate 701 and a second substrate 702. A first die 710 and a second die 740 are attached to the second substrate 702. In an embodiment, the first die 710 is communicatively coupled to the second die 740 by a bridge 742. In an embodiment, the first die 710 is a photonics die that is part of a photonics module. The photonics module may be substantially similar to the photonics module 200 in FIGS. 2A and 2B.

In an embodiment, the photonics module comprises a fiber connector 720 that secures an optical fiber 715 in a V-groove 712 of the photonics die 710. The optical fiber 715 may terminate at a reflective surface 727. The reflective surface 727 may optically couple the optical fiber 715 to a micro lens 728 on a surface of the fiber connector 720. The micro lens 728 may be coupled to another micro lens 745 on the first substrate 701. An optical path between micro lens 728 and micro lens 745 may pass through an opening 744 through the first substrate 701.

In an embodiment, the photonics die 710 and the fiber connector 720 may be attached to a carrier substrate 705. The carrier substrate 705 may separate the photonics die 710 and the fiber connector 720 from an IHS 741.

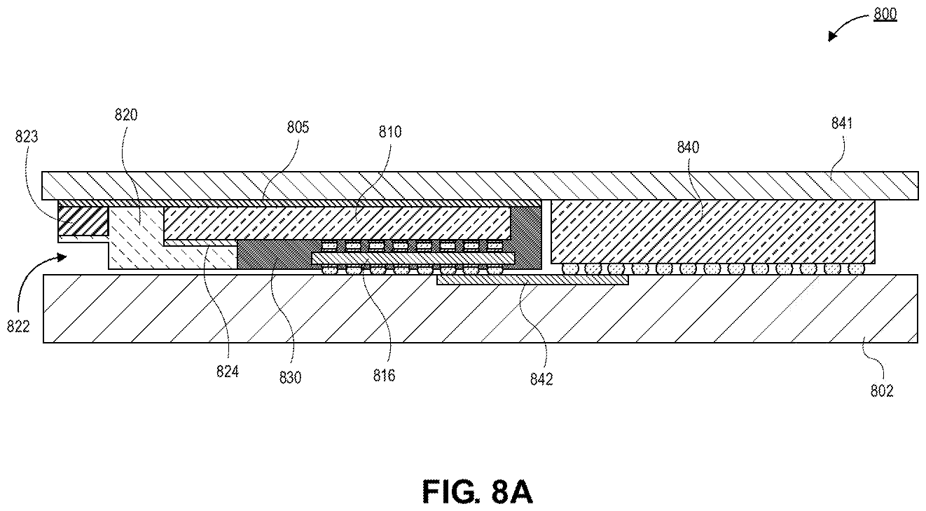

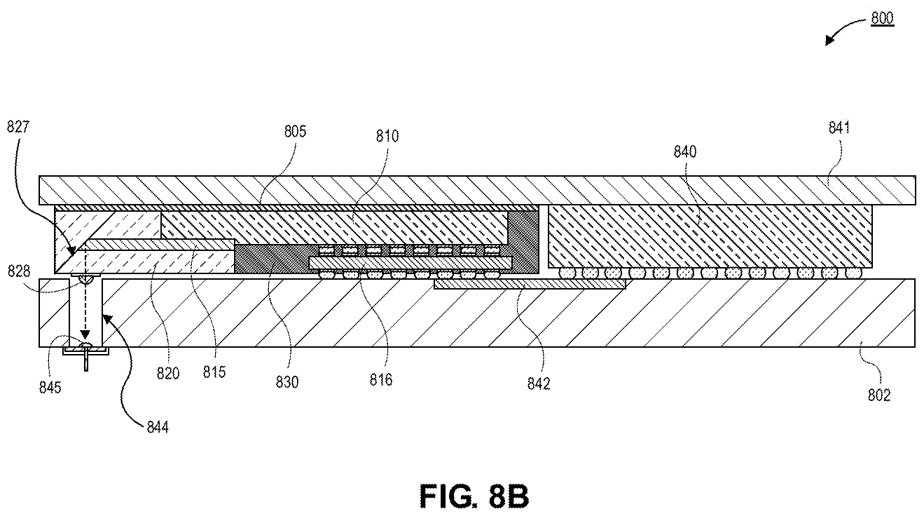

Referring now to FIG. 8A, a cross-sectional illustration of an electronic package 800 is shown, in accordance with an embodiment. In an embodiment, the electronic package 800 comprises a substrate 802 with a first die 810 and a second die 840 attached to the substrate 802. The first die 810 and the second die 840 may be communicatively coupled to each other by a bridge 842 in the substrate 802. In an embodiment, the first die 810 is a photonics die that is part of a photonics module. For example, the photonics module may be substantially similar to the photonics module 300 in FIGS. 3A-3C.

In an embodiment, the photonics die 810 is separated from the substrate 802 by an interposer 816. The interposer 816 and a portion of the photonics die 810 may be surrounded by a mold layer 830. In an embodiment, the photonics module may further comprise a fiber connector 820. The fiber connector 820 and an epoxy 824 may secure optical fibers (not shown) to V-grooves in the photonics die 810. In an embodiment, a portion of an alignment hole 822 may also be provided along an edge of the fiber connector 820. A portion of the alignment hole 822 may be surrounded by a magnetic material 823.

In an embodiment, the photonics die 810 and the fiber connector 820 may be attached to a carrier substrate 805. The carrier substrate 805 may separate the photonics die 810 and the fiber connector 820 from an IHS 841.

Referring now to FIG. 8B, a cross-sectional illustration of an electronic package 800 is shown, in accordance with an additional embodiment. The electronic package 800 in FIG. 8B may be substantially similar to the electronic package 800 in FIG. 8A, with the exception of the photonics module. Particularly, the photonics module in FIG. 8B may be substantially similar to the photonics module 400 in FIGS. 4A and 4B.

For example, the photonics module may include a fiber connector 820 that includes a reflective surface 827. The optical fiber 815 may terminate at the reflective surface 827. The optical fiber 815 may be optically coupled to a micro lens 828 on a surface of the fiber connector 820. The micro lens 828 may be coupled to another micro lens 845 on the substrate 802. An optical path between micro lens 828 and micro lens 845 may pass through an opening 844 through the substrate 802.

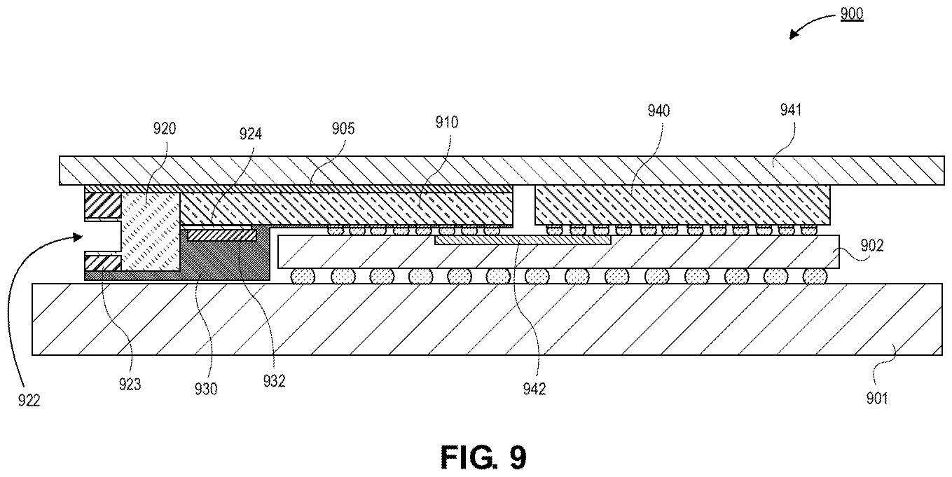

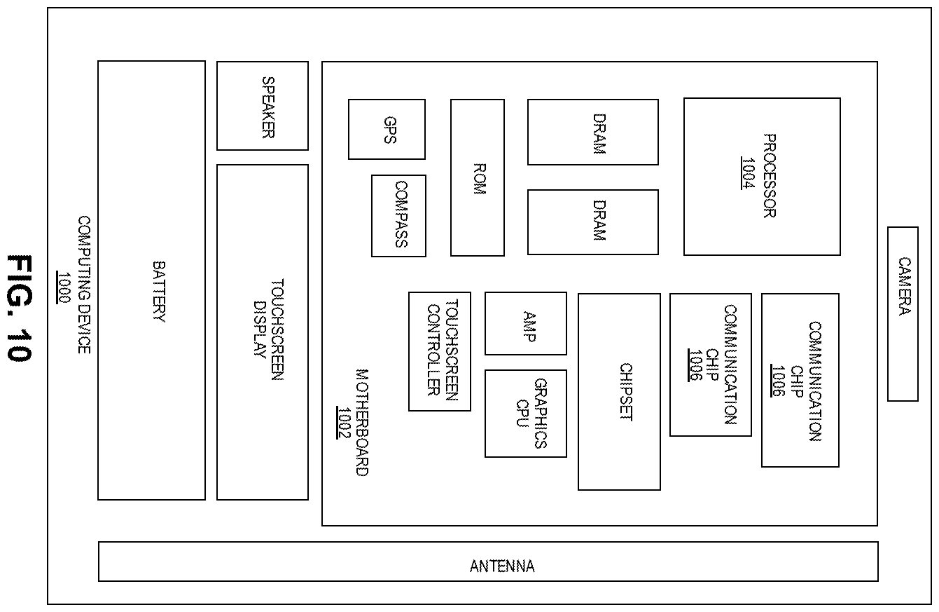

Referring now to FIG. 9, a cross-sectional illustration of an electronic package 900 is shown, in accordance with an embodiment. In an embodiment, the electronic package 900 comprises a first substrate 901 and a second substrate 902. A first die 910 and a second die 940 are attached to the second substrate 902. The first die 910 may be communicatively coupled to the second die 940 by a bridge 942 in the second substrate 902. In an embodiment, the first die 910 may be a photonics die. The photonics die 910 may overhang an edge of the second substrate 902.

In an embodiment, the photonics die 910 may be part of a photonics module. Particularly, the photonics module in FIG. 9 may be substantially similar to the photonics module 500 in FIGS. 5A and 5B. That is, a buffer lid 932 and epoxy 924 may secure optical fibers (not shown) into V-grooves in the photonics die 910. In an embodiment, the buffer lid 932 and the fiber connector 920 may be embedded in a mold layer 930. An alignment hole 922 may be formed into the fiber connector 920. The alignment hole 922 may be surrounded by a magnetic material 923.

In an embodiment, the photonics die 910 and the fiber connector 920 may be attached to a carrier substrate 905. The carrier substrate 905 may separate the photonics die 910 and the fiber connector 920 from an IHS 941.

FIG. 10 illustrates a computing device 1000 in accordance with one implementation of the invention. The computing device 1000 houses a board 1002. The board 1002 may include a number of components, including but not limited to a processor 1004 and at least one communication chip 1006. The processor 1004 is physically and electrically coupled to the board 1002. In some implementations the at least one communication chip 1006 is also physically and electrically coupled to the board 1002. In further implementations, the communication chip 1006 is part of the processor 1004.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 1006 enables wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 1006 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 1000 may include a plurality of communication chips 1006. For instance, a first communication chip 1006 may be dedicated to shorter range wireless communications such as Wi-Fi and Bluetooth and a second communication chip 1006 may be dedicated to longer range wireless communications such as GPS, EDGE, GPRS, CDMA, WiMAX, LTE, Ev-DO, and others.

The processor 1004 of the computing device 1000 includes an integrated circuit die packaged within the processor 1004. In some implementations of the invention, the integrated circuit die of the processor 1004 may be part of an electronic package that comprises a photonics module with a fiber connector, in accordance with embodiments described herein. The term “processor” may refer to any device or portion of a device that processes electronic data from registers and/or memory to transform that electronic data into other electronic data that may be stored in registers and/or memory.

The communication chip 1006 also includes an integrated circuit die packaged within the communication chip 1006. In accordance with another implementation of the invention, the integrated circuit die of the communication chip 1006 may be part of an electronic package that comprises a photonics module with a fiber connector, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: a photonics module, comprising: a carrier substrate; a photonics die over the carrier substrate, wherein the photonics die has a first surface facing away from the carrier substrate and a second surface facing the carrier substrate, and wherein a plurality of V-grooves are disposed on the first surface proximate to an edge of the photonics die; and a fiber connector attached to the photonics die, wherein the fiber connector couples a plurality of optical fibers to the photonics die, wherein individual ones of the plurality of optical fibers are positioned in the V-grooves.

Example 2: the photonics module of Example 1, wherein the fiber connector is over the first surface of the photonics die and a sidewall surface of the photonics die.

Example 3: the photonics module of Example 1 or Example 2, further comprising: an alignment hole in the fiber connector.

Example 4: the photonics module of Example 3, wherein a magnet surrounds at least a portion of the alignment hole.

Example 5: the photonics module of Examples 1-4, wherein the plurality of optical fibers terminate at a reflective surface within the fiber connector, wherein the reflective surface optically couples the plurality of optical fibers with an array of micro lenses on a surface of the fiber connector.

Example 6: the photonics module of Examples 1-5, further comprising: an interposer over the first surface of the photonics die; and a mold layer over the interposer.

Example 7: the photonics module of Example 6, wherein the plurality of optical fibers terminate at a reflective surface within the fiber connector, wherein the reflective surface optically couples the plurality of optical fibers with an array of micro lenses on a surface of the fiber connector.

Example 8: the photonics module of Example 6 or Example 7, wherein a top surface of the mold layer is substantially coplanar with a top surface of the fiber connector.

Example 9: the photonics module of Examples 1-8, further comprising: a buffer lid over the V-grooves to secure the plurality of optical fibers; and a mold layer over the buffer lid and over the fiber connector.

Example 10: the photonics module of Examples 1-9, wherein the plurality of optical fibers comprises twenty-four optical fibers.

Example 11: an electronic package, comprising: a first substrate; a second substrate attached to the first substrate; a die attached to the second substrate; a photonics die attached to the second substrate, wherein the photonics die overhangs the second substrate, and wherein the photonics die has a first surface facing the second substrate and a second surface facing away from the second substrate; a fiber connector attached to the photonics die, wherein the fiber connector couples a plurality of optical fibers to the first surface of the photonics die; and a carrier substrate attached to the second surface of the photonics die and the fiber connector.

Example 12: the electronic package of Example 11, wherein the fiber connector is supported by the first substrate.

Example 13: the electronic package of Example 11 or Example 12, wherein the plurality of optical fibers terminate at a reflective surface, and wherein the reflective surface optically couples the plurality of optical cables to an array of micro lenses.

Example 14: the electronic package of Example 13, wherein an optical path from the reflective surface to the array of micro lenses passes through the first substrate.

Example 15: the electronic package of Examples 11-14, further comprising: a mold layer between the fiber connector and the first substrate, and wherein the mold layer secures a buffer lid against the plurality of optical fibers.

Example 16: the electronic package of Examples 11-15, further comprising: an alignment hole in the fiber connector.

Example 17: the electronic package of Example 16, further comprising: a magnetic material surrounding at least a portion of the alignment hole.

Example 18: the electronic package of Examples 11-17, wherein the first substrate is an interposer, and wherein the second substrate is a patch substrate.

Example 19: the electronic package of Examples 11-17, wherein the first substrate is a board.

Example 20: a method of forming photonics module, comprising: attaching a plurality of photonics dies to a carrier, wherein individual ones of the photonics dies comprise V-grooves in a surface facing away from the carrier; attaching a fiber connector to each of the plurality of photonics dies, wherein the fiber connector comprises a plurality of optical fibers that are inserted in the V-grooves; singulating the carrier to provide a plurality of photonics modules; and testing an optical coupling between the individual ones of the plurality of photonics dies and the optical fibers in the plurality of photonics modules.

Example 21: the method of Example 20, wherein testing optical coupling is performed at the same time as electrical testing of the photonics dies.

Example 22: the method of Example 20 or Example 21, wherein the fiber connector comprises alignment holes surrounded by a magnetic material.

Example 23: an electronic package, comprising: a first substrate; a second substrate over the first substrate; a die attached to the second substrate; and a photonics module attached to the second substrate, wherein the photonics module overhangs an edge of the second substrate, and wherein the photonics module comprises: a carrier substrate; a photonics die attached to the carrier substrate, wherein the photonics die has a first surface facing the second substrate and a second surface facing the carrier substrate, and wherein a plurality of V-grooves are disposed on the first surface proximate to an edge of the photonics die; and a fiber connector attached to the photonics die, wherein the fiber connector couples a plurality of optical fibers to the photonics die, wherein individual ones of the plurality of optical fibers are positioned in the V-grooves.

Example 24: the electronic package of Example 23, wherein the fiber connector is over the first surface of the photonics die and a sidewall surface of the photonics die.

Example 25: the electronic package of Example 23 or Example 24, further comprising: an alignment hole in the fiber connector.

What is claimed is:

1. A photonics module, comprising:
a carrier substrate;
a photonics die over the carrier substrate, wherein the photonics die has a first surface facing away from the carrier substrate and a second surface facing the carrier substrate, and wherein a plurality of V-grooves are disposed on the first surface proximate to an edge of the photonics die; and
a fiber connector attached to the photonics die, wherein the fiber connector couples a plurality of optical fibers to the photonics die, wherein individual ones of the plurality of optical fibers are positioned in the V-grooves.

2. The photonics module of claim 1, wherein the fiber connector is over the first surface of the photonics die and a sidewall surface of the photonics die.

3. The photonics module of claim 1, further comprising:
an alignment hole in the fiber connector.

4. The photonics module of claim 3, wherein a magnet surrounds at least a portion of the alignment hole.

5. The photonics module of claim 1, wherein the plurality of optical fibers terminate at a reflective surface within the fiber connector, wherein the reflective surface optically couples the plurality of optical fibers with an array of micro lenses on a surface of the fiber connector.

6. The photonics module of claim 1, further comprising:
an interposer over the first surface of the photonics die; and
a mold layer over the interposer.

7. The photonics module of claim 6, wherein the plurality of optical fibers terminate at a reflective surface within the fiber connector, wherein the reflective surface optically couples the plurality of optical fibers with an array of micro lenses on a surface of the fiber connector.

8. The photonics module of claim 6, wherein a top surface of the mold layer is substantially coplanar with a top surface of the fiber connector.

9. The photonics module of claim 1, further comprising:
a buffer lid over the V-grooves to secure the plurality of optical fibers; and
a mold layer over the buffer lid and over the fiber connector.

10. The photonics module of claim 1, wherein the plurality of optical fibers comprises twenty-four optical fibers.

11. An electronic package, comprising:
a first substrate;
a second substrate attached to the first substrate;
a die attached to the second substrate;
a photonics die attached to the second substrate, wherein the photonics die overhangs the second substrate, and wherein the photonics die has a first surface facing the second substrate and a second surface facing away from the second substrate;
a fiber connector attached to the photonics die, wherein the fiber connector couples a plurality of optical fibers to the first surface of the photonics die; and
a carrier substrate attached to the second surface of the photonics die and the fiber connector.

12. The electronic package of claim 11, wherein the fiber connector is supported by the first substrate.

13. The electronic package of claim 11, wherein the plurality of optical fibers terminate at a reflective surface, and wherein the reflective surface optically couples the plurality of optical cables to an array of micro lenses.

14. The electronic package of claim 13, wherein an optical path from the reflective surface to the array of micro lenses passes through the first substrate.

15. The electronic package of claim 11, further comprising:
a mold layer between the fiber connector and the first substrate, and wherein the mold layer secures a buffer lid against the plurality of optical fibers.

16. The electronic package of claim 11, further comprising:
an alignment hole in the fiber connector.

17. The electronic package of claim 16, further comprising:
a magnetic material surrounding at least a portion of the alignment hole.

18. The electronic package of claim 11, wherein the first substrate is an interposer, and wherein the second substrate is a patch substrate.

19. The electronic package of claim 11, wherein the first substrate is a board.

20. A method of forming photonics module, comprising:
attaching a plurality of photonics dies to a carrier, wherein individual ones of the photonics dies comprise V-grooves in a surface facing away from the carrier;
attaching a fiber connector to each of the plurality of photonics dies, wherein the fiber connector comprises a plurality of optical fibers that are inserted in the V-grooves;
singulating the carrier to provide a plurality of photonics modules; and
testing an optical coupling between the individual ones of the plurality of photonics dies and the optical fibers in the plurality of photonics modules.

21. The method of claim 20, wherein testing optical coupling is performed at the same time as electrical testing of the photonics dies.

22. The method of claim 20, wherein the fiber connector comprises alignment holes surrounded by a magnetic material.

23. An electronic package, comprising:
a first substrate;
a second substrate over the first substrate;
a die attached to the second substrate; and
a photonics module attached to the second substrate, wherein the photonics module overhangs an edge of the second substrate, and wherein the photonics module comprises:
a carrier substrate;
a photonics die attached to the carrier substrate, wherein the photonics die has a first surface facing the second substrate and a second surface facing the carrier substrate, and wherein a plurality of V-grooves are disposed on the first surface proximate to an edge of the photonics die; and
a fiber connector attached to the photonics die, wherein the fiber connector couples a plurality of optical fibers to the photonics die, wherein individual ones of the plurality of optical fibers are positioned in the V-grooves.

24. The electronic package of claim 23, wherein the fiber connector is over the first surface of the photonics die and a sidewall surface of the photonics die.

25. The electronic package of claim 23, further comprising:
an alignment hole in the fiber connector.
